(19) United States
(12) Patent Application Publication
(10) Pub. No.: US 2015/0149045 A1
(43) Pub. Date: May 28, 2015

(54) VEHICLE HEADLAMP LIGHT DISTRIBUTION CONTROL APPARATUS

(71) Applicants: DENSO CORPORATION, Kariya-city, Aichi-pref. (JP); TOYOTA JIDOSHA KABUSHIKI KAISHA, Toyota-shi, Aichi-ken (JP)

(72) Inventors: Ryu Mizuno, Kariya-shi (JP); Hajime Kasai, Kariya-shi (JP); Tatsuya Takagaki, Nisshin-shi (JP); Kazuhiko Nakashima, Miyoshi-shi (JP)

(21) Appl. No.: 14/410,814

(22) PCT Filed: Jun. 19, 2013
(86) PCT No.: PCT/JP2013/066854

§ 371 Date: Dec. 23, 2014

(30) Foreign Application Priority Data
Jun. 25, 2012 (JP) 2012-142020

(51) Int. Cl. B60Q 1/08

(52) U.S. Cl. CPC B60Q 1/08; B60Q 2300/41
USPC 701/49

(57) ABSTRACT

In a vehicle headlamp light distribution control system which changes a shaded range so as to track a position of a forward vehicle and terminates the tracking when the forward vehicle moves away from the front of a system-mounted vehicle by a tracking limit, how right and left margins of the shaded range for a tracking lag and the tracking limit is determined is arranged to realize adequate dazzle and improve the visibility to a driver of the system-mounted vehicle. It is determined whether the forward vehicle is a preceding vehicle or an oncoming vehicle. When the forward vehicle is the preceding vehicle, optical axis control margins that are right and left margins for the shaded range for the tracking lag are set to be smaller than those when the forward vehicle is the oncoming vehicle to widen the maximum shading range according to the tracking limit.

### TECHNICAL FIELD

The present invention generally relates to a vehicle headlamp light distribution control apparatus.

### BACKGROUND ART

For instance, Patent Literature 1 discloses a shade control system which controls shades installed in headlamps for vehicles. This system arranges cut-off lines slightly outside right and left sides of a forward vehicle which is being tracked traveling ahead of a vehicle in which the shade control system is mounted (which will also be referred to as a system-mounted vehicle below) and controls the shades in the headlamps to define a shaded range between the cut-off lines in order to avoid dazzling the forward vehicle.

A system is also known which stops the light-blocked range from tracking movement of the forward vehicle when the forward vehicle has moved away from the front of the system-mounted vehicle by a given distance (see Non-Patent Literature 1).

### PRIOR ART TECHNICAL DOCUMENT

### Patent Literature

### Patent Literature 1 Unexamined Patent Application Publication 2009-227088

### Patent Literature 2 Unexamined Patent Application Publication 2008-293116

### Patent Literature 3 Unexamined Patent Application Publication 2008-168660

### Patent Literature 4 Unexamined Patent Application Publication 2008-094249

### Patent Literature 5 Unexamined Patent Application Publication 2008-040615

### Patent Literature 6 Unexamined Patent Application Publication 2009-227088

### Patent Literature 7 Unexamined Patent Application Publication 2009-211963

### NON-PATENT LITERATURE

Non-Patent Literature 1 “HEADLAMPS, [online], HELLA KGaA Huechk & Co., searched on Jun. 20, 2012 on the Internet URL: http//www.hella.com/hella-com/ 620. html”

### SUMMARY OF THE INVENTION

### Problem to be Solved by the Invention

The inventors have first studied a tracking lag in the above headlamp light distribution control for vehicles. It takes a little time to achieve detection of a position of a forward vehicle, determination of the shaded range according to the detected position, operation of an actuator according to the determined shaded range. Fast movement of the forward vehicle may, therefore, result in a lag in actually forming a shaded range behind the movement of the forward vehicle to be shaded.

The shade control system in the above Patent Literature 1 defines the right and left sides of the shaded range slightly outside the sides of the preceding vehicle to compensate for the tracking lag.

However, uniform definition of the shaded range to compensate for an expected maximum tracking lag realizes adequate dazzle suppression, but frequently causes the visibility to a driver of the system-mounted vehicle to drop to an undesirable level.

In view of the above problem, it is the first object of the invention to arrange how to determine right and left margins of a shaded range for a lag in tracking a forward vehicle to realize adequate dazzle and improve the visibility of a driver of the system-mounted vehicle in a headlamp light distribution control apparatus for vehicles which changes a shaded range so as to track the forward vehicle.

The tracking lag becomes increased as the forward vehicle moves away from the front of the system-mounted vehicle in a lateral direction.

This is because the speed of lateral movement of the forward vehicle, as viewed from the system-mounted vehicle, will increase as the forward vehicle comes close to the system-mounted vehicle, so that it moves laterally away from the front of the system-mounted vehicle.

The tracking control may be stopped, like in Non-Patent Literature 1, before the tracking lag becomes increased by terminating the tracking control for the shaded range when the forward vehicle moves away from the front of the system-mounted vehicle by a given distance (i.e., a tracking limit).

However, selection of the above tracking limit to compensate for the case where the tracking lag becomes increased most quickly results in an almost zero possibility that the increase in tracking lag leads to a failure in avoiding dazzling the forward vehicle, but frequently causes the visibility of the driver of the system-mounted vehicle to drop to an unwanted level.

In view of the above problem, it is the second object of the invention to arrange how to determine the tracking limit to realize adequate dazzle and improve the visibility for a driver of the system-mounted vehicle in a headlamp light distribution control apparatus for vehicles which changes a shaded range so as to track a forward vehicle and terminates such tracking when the preceding vehicle moves away from the front of the system-mounted vehicle by the tracking limit.

### Means Solving the Problems

The invention, as recited in claim 1, for achieving the first object is a vehicle headlamp light distribution control apparatus which controls a light distribution of a headlamp (11L, 11R) of a vehicle. The vehicle headlamp light distribution control apparatus comprises: acquiring means (100, 200) for acquiring preceding/oncoming vehicle information for specifying positional coordinates that are a marked position of a forward vehicle running in front of said vehicle and determining whether the forward vehicle is a preceding vehicle or an oncoming vehicle; vehicle type determining means (105, 205, 210) for determining a type of said forward vehicle based on the preceding/oncoming vehicle information, as acquired by said acquiring means; optical axis control margin setting means (120, 130, 225) for setting an optical axis control margin (34) based on a result of determination made by said vehicle type determining means, said optical axis control margin setting means setting the optical axis control margin when said vehicle type determining means determines that the oncoming vehicle is in front of said vehicle to be greater than that when said vehicle type determining means determines that the preceding vehicle is in front of said vehicle; cut-off line calculating means (135, 235) for, when said headlamp is a left headlamp (11L), defining a location shifted from the positional coordinates of said marked position to the left by said optical axis control margin as a cut-off line of the left headlamp or, when said headlamp is a right headlamp (11R), defining a location shifted from the positional coordinates of said marked position to the right by said optical axis control margin as a cut-off line of the right headlamp based on the positional coordinates of the marked position of said forward vehicle, as acquired by said acquiring means; and control means (140, 145, 150, 240, 245, 250) for, when said headlamp is the left headlamp (11L), controlling a light-distribution range of the left headlamp so as to shade a right side of said cut-off line or, when said headlamp is the right headlamp (11R), controlling a light distribution range of the right headlamp so as to shade a left side of said cut-off line.

The reason for the above is because the oncoming vehicle is usually higher in relative speed to the system-mounted vehicle than the preceding vehicle, so that the lateral velocity of the oncoming vehicle relative to the system-mounted vehicle is higher than that of the preceding vehicle, thus resulting in an increase in an adverse effect resulting from the lag in tracking the shaded range. In other words, in the case where the forward vehicle is the preceding vehicle, the adverse effect arising from the lag in tracking the shaded range is relatively small. There is, therefore, a low possibility that the preceding vehicle moves out of the shaded range blocked by the shade when the optical axis control margin is decreased to widen the light distribution range.

In the above way, the optical axis control margin is changed depending upon whether the forward vehicle is the preceding vehicle or the oncoming vehicle, thereby avoiding dazzling the forward vehicle and also optimizing the forward visibility depending upon the type of the forward vehicle.

The invention, as recited in claim 2, for achieving the first object is a vehicle headlamp light distribution control apparatus which controls a light distribution of a headlamp (11L, 11R) of a vehicle. The vehicle headlamp light distribution control apparatus comprises: acquiring means (200) for acquiring positional coordinates of a marked position of a forward vehicle running in front of said vehicle; optical axis control margin setting means (225) for, when the positional coordinates of the marked position, as derived by said acquiring means, are not present in front of said vehicle, setting said optical axis control margin to be greater than that when the positional coordinates of the marked position are present in front of said vehicle; cut-off line calculating means (235) for, when said headlamp is a left headlamp (11L), defining a location shifted from the positional coordinates of said marked position to the left by said optical axis control margin as the cut-off line of the left headlamp or, when said headlamp is a right headlamp (11R), defining a location shifted from the positional coordinates of said marked position to the right by said optical axis control margin as the cut-off line of the right headlamp based on the positional coordinates of the marked position of said forward vehicle, as acquired by said acquiring means; and control means (240, 245, 250) for, when said headlamp is the left headlamp (11L), controlling a light-distribution range of the left headlamp so as to shade a right side of said cut-off line or, when said headlamp is the right headlamp (11R), controlling a light distribution range of the right headlamp so as to shade a left side of said cut-off line.

The reason why when the forward vehicle is laterally offset from the front of the system-mounted vehicle the optical axis control margin is set relatively great is because the more the preceding vehicle is shifted from the center in the lateral direction, the higher the probability that the preceding vehicle is approaching the system-mounted vehicle. In such a case, the speed at which the preceding vehicle moves relative to the system-mounted vehicle in the lateral direction is often high, thus resulting in a high probability that an adverse effect on the preceding vehicle which arises from the lag in tracking the shaded range increases.

In the above way, the optical axis control margin is changed depending upon whether the forward vehicle is offset from the front of the system-mounted vehicle or not, thereby avoiding dazzling the forward vehicle and also optimizing the forward visibility depending upon the type of the forward vehicle.

The invention, as recited in claim 3, for achieving the first object is a vehicle headlamp light distribution control apparatus which controls a light distribution of a headlamp (11L, 11R) of a vehicle. The vehicle headlamp light distribution control apparatus comprises:

acquiring means (200) for acquiring positional coordinates of a marked position of a forward vehicle running in front of said vehicle; optical axis control margin setting means (225) for setting said optical axis control margin when said vehicle is running on a curve to be greater than that when said vehicle is running straight; cut-off line calculating means (235) for, when said headlamp is a left headlamp (11L), defining a location shifted from the positional coordinates of said marked position to the left by said optical axis control margin as the cut-off line of the left headlamp or, when said headlamp is a right headlamp (11R), defining a location shifted from the positional coordinates of said marked position to the right by said optical axis control margin as the cut-off line of the right headlamp based on the positional coordinates of the marked position of said forward vehicle, as acquired by said acquiring means; and control means (240, 245, 250) for, when said headlamp is the left headlamp (11L), controlling a light-distribution range of the left headlamp so as to shade a right side of said cut-off line or, when said headlamp is the right headlamp (11R), controlling a light distribution range of the right headlamp so as to shade a left side of said cut-off line.

The reason why the optical axis control margin is set relatively great during running on a curve is because the speed at which a forward vehicle moves relative to the system-mounted vehicle in the lateral direction is often high, thus resulting in a high possibility that the effect on the forward vehicle which results from the lag in tracking the shaded range increases even when the speed of the system-mounted vehicle is low.

In the above way, the optical axis control margin is changed depending upon whether the system-mounted vehicle is running straight or on a curve, thereby avoiding dazzling the forward vehicle and also optimizing the forward visibility depending upon the type of the forward vehicle.

The invention, as recited in claim 4, for achieving the first object is a vehicle headlamp light distribution control apparatus which controls a light distribution of a headlamp (11L, 11R) of a vehicle. The vehicle headlamp light distribution control apparatus comprises: acquiring means (200) for acquiring positional coordinates of a marked position of a forward vehicle running in front of said vehicle; optical axis control margin setting means (225) for setting said optical axis control margin to be smaller with an increase in speed of said vehicle; cut-off line calculating means (235) for, when said headlamp is a left headlamp (11L), defining a location shifted from the positional coordinates of said marked position to the left by said optical axis control margin as the cut-off line of the left headlamp or, when said headlamp is a right headlamp (11R), defining a location shifted from the positional coordinates of said marked position to the right by said optical axis control margin as the cut-off line of the right headlamp based on the positional coordinates of the marked position of said forward vehicle, as acquired by said acquiring means; and control means (240, 245, 250) for, when said headlamp is the left headlamp (11L), controlling a light-distribution range of the left headlamp so as to shade a right side of said cut-off line or, when said headlamp is the right headlamp (11R), controlling a light distribution range of the right headlamp so as to shade a left side of said cut-off line.

In the above way, the optical axis control margin is changed as a function of the speed of the system-mounted vehicle, thereby avoiding dazzling the forward vehicle and also optimizing the forward visibility depending upon the type of the forward vehicle.

The invention, as recited in claim 5, for achieving the second object is a vehicle headlamp light distribution control apparatus which controls a light distribution of a headlamp (11L, 11R) of a vehicle. The vehicle headlamp light distribution control apparatus comprises: acquiring means (100, 200) for acquiring preceding/oncoming vehicle information for specifying positional coordinates that are a marked position of a forward vehicle running in front of said vehicle and determining whether the forward vehicle is a preceding vehicle or an oncoming vehicle; vehicle type determining means (105, 205, 210) for determining a type of said forward vehicle based on the preceding/oncoming vehicle information, as acquired by said acquiring means; maximum shading range setting means (115, 125, 220) for setting a maximum shading range (36) that is a width between a given controlled center (31) and a cut-off limit position (35) based on a result of determination made by said vehicle type determining means, said maximum shading range setting means setting the maximum shading range to be smaller when said vehicle type determining means determines that the oncoming vehicle is in front of said vehicle than that when said vehicle type determining means determines that the preceding vehicle is in front of said vehicle; cut-off line calculating means (135, 235) for calculating a cut-off line of said headlamp the based on the positional coordinates of the marked position of said forward vehicle, as acquired by said acquiring means; and control means (140, 145, 150, 240, 245, 250) for determining whether said cut-off line lies in said maximum shading range (36) or not, when said cut-off line lies in said maximum shading range and said headlamp is a left headlamp (11L), said control means controlling a light-distribution range of the left headlamp so as to shade a right side of said cut-off line or, when said cut-off line lies out of said maximum shading range and said headlamp is a right headlamp (11R), controlling a light distribution range of the right headlamp so as to shade a left side of said cut-off line.

The reason for the above is because the oncoming vehicle is usually higher in relative speed to the vehicle 10 than the preceding vehicle, so that the lateral velocity of the oncoming vehicle relative to the system-mounted vehicle is higher than that of the preceding vehicle, thus resulting in an increase in an adverse effect of the lag when tracking the shaded range. In other words, in the case where the forward vehicle is the preceding vehicle, the influence arising from the lag in tracking the shaded range is relatively small. There is, therefore, a low possibility that a preceding vehicle will move out of the shaded range blocked by the shade when the optical axis control margin is decreased to widen the light distribution range.

In the above way, the optical axis control margin is changed depending on whether the forward vehicle is the preceding vehicle or the oncoming vehicle, thereby avoiding dazzling the forward vehicle and also optimizing the forward visibility depending upon the type of the forward vehicle.

The invention, as recited in claim 6, for achieving the first object is a vehicle headlamp light distribution control apparatus which controls a light distribution of a headlamp (11L, 11R) of a vehicle. The vehicle headlamp light distribution control apparatus comprises: acquiring means (200) for acquiring preceding/oncoming vehicle information for specifying positional coordinates that are a marked position of a forward vehicle running in front of said vehicle and determining whether the forward vehicle is a preceding vehicle or an oncoming vehicle; maximum shading range setting means (220) for setting a maximum shading range (36) that is a width between a given controlled center (31) and a cut-off limit position (35) to be smaller with an increase in speed of said vehicle; cut-off line calculating means (135, 235) for calculating a cut-off line of said headlamp based on the based on the positional coordinates of the marked position of said forward vehicle, as acquired by said acquiring means; and control means (140, 145, 150, 240, 245, 250) for determining whether said cut-off line lies in said maximum shading range (36) or not, when said cut-off line lies in said maximum shading range and said headlamp is a left headlamp (11L), said control means controlling a light-distribution range of the left headlamp so as to shade a right side of said cut-off line or, when said cut-off line lies in said maximum shading range and said headlamp is a right headlamp (11R), controlling a light distribution range of the right headlamp so as to shade a left side of said cut-off line, and when said cut-off line lies out of said maximum shading range, said control means placing the light distribution of said headlamp in a low-beam mode.

In the above way, the maximum shading range is changed as a function of the speed of the system-mounted vehicle, thereby avoiding dazzling the forward vehicle and also optimizing the forward visibility depending upon the type of the forward vehicle.

Symbols in brackets represent correspondence relation between terms in claims and terms described in embodiments which will be discussed later.

### BRIEF EXPLANATION OF DRAWINGS

FIG. 1 is an illustration which shows a structure of a vehicle headlamp light distribution control system 1 according to an embodiment of the invention.

FIG. 2 is an illustration which shows a light distribution range 55 in a right and left high-beam mode.

FIG. 3 is an illustration which shows a light distribution range 56 in a right and left middle high-beam mode.

FIG. 4 is an illustration which shows a light distribution range 57 in a left middle high-beam/right low-beam mode.

FIG. 5 is an illustration of the light-distribution of FIG. 3, as viewed from a system-mounted vehicle.

FIG. 6 is a flowchart of processing executed by an ECU in the first embodiment.

FIG. 7 is a graph which represents a maximum shading range and an optical control margin in light distribution modes A and B.

FIG. 8 is an illustration which exemplifies an optical axis control margin 34 and a maximum shading range 36.

FIG. 9 is an illustration which shows a case where a location 33 shifted to the right from a rightmost light source 21R by an optical axis control margin 34 exceeds a cut-off limit position 35 to the right side.

FIG. 10 is a flowchart of processing executed by an ECU in the second embodiment.

FIG. 11 is a set matrix of a maximum shading range.

FIG. 12 is a set matrix of an optical axis control margin.

### DESCRIPTION OF EMBODIMENTS

### First Embodiment

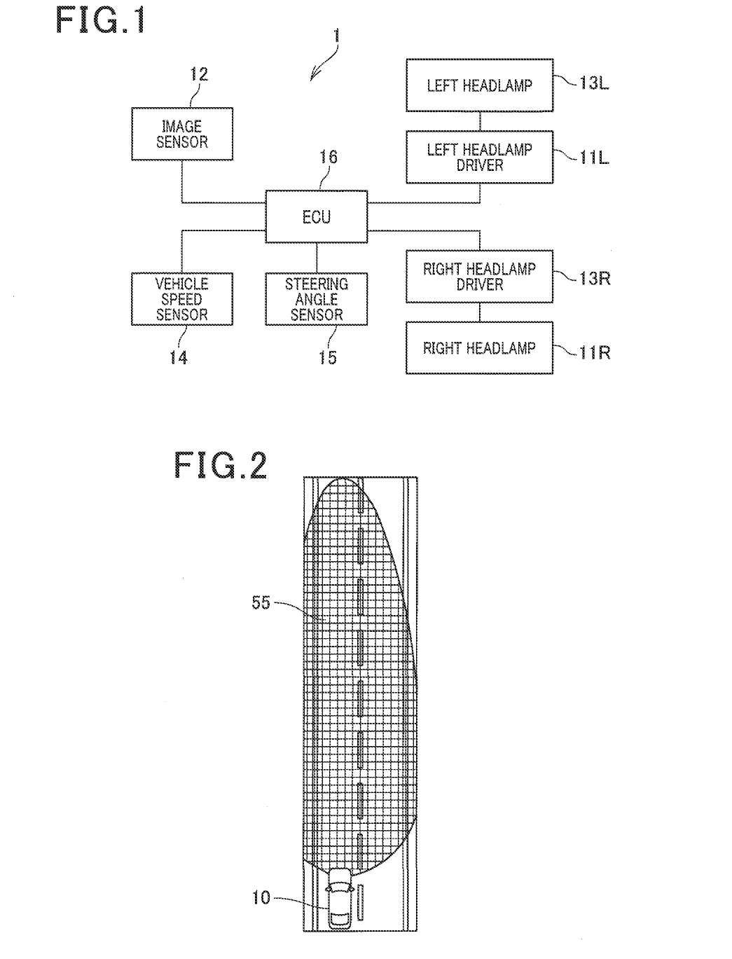

An embodiment of the invention will be described below. The headlamp light distribution control system 1 is, as illustrated in FIG. 1, installed in a vehicle. The headlamp light distribution control system 1 controls two headlamps of the vehicle (i.e., the left headlamp 11L disposed on the left side of the vehicle and the right headlamp 11R disposed on the right side of the vehicle) and is equipped with the image sensor 12, the left headlamp driver 13L, the right headlamp driver 13R, the vehicle speed sensor 14, the steering angle sensor 15, and the ECU 16.

The image sensor 12 is equipped with a camera and a detecting circuit. The camera sequentially captures an image of a forward view (a road surface etc.) of the vehicle (e.g., in a cycle of 1/30 sec.) and sequentially outputs the captured image to the detecting circuit.

The detecting circuit performs known image processing (image recognition processing) on each image outputted from the camera and tries to detect a light source (an object recognizable as a vehicle by means of a brightness higher than a given value, a shape similar to a given shape, or a color closer to a given color). When one or a plurality of light sources are detected on the captured image, coordinates of the position (positional coordinates on the capture image) of each of the light sources (corresponding to one line on a marked position) are determined.

The detecting circuit also determines whether the detected one or plurality of light sources are light sources of a preceding vehicle (i.e., tail lamps) or an oncoming vehicle (i.e., headlamps). As the way of determining whether the light sources are light sources of a preceding vehicle or an oncoming vehicle, known methods, as described in Patent Literatures 2 to 5, may be used. Specifically, if the color of the light source falls within a given range close to white, the light source may be determined as a light source of the oncoming vehicle, while the color falls in a given range close to red, the light source may be determined as a light source of the preceding vehicle.

The detecting circuit outputs the positional coordinates of each light source, as derived in the above way, on the captured image and preceding/oncoming vehicle information about whether the light source is the preceding vehicle or the oncoming vehicle to the ECU 16 as camera information.

The left headlamp driver 13L is an actuator to control a light distribution range of the left headlamp 11L mounted on the left side of the center of the vehicle. The left headlamp driver 13L is equipped with a swivel motor which changes or swivels an irradiation direction (i.e., a direction of an optical axis) of the left headlamp 11L and a shade mechanism motor which drives a shade mechanism installed in the left headlamp 11L.

The right headlamp driver 13R is an actuator to control a light distribution range of the right headlamp 11R mounted on the right side of the center of the vehicle. The right headlamp driver 13R is equipped with a swivel motor which changes or swivels a radiation direction (i.e., a direction of an optical axis) of the right headlamp 11R and a shade mechanism motor which drives a shade mechanism installed in the right headlamp 11R.

The shade mechanism installed in each of the headlamps 11L and 11R is a known mechanism for blocking a portion of light of the corresponding headlamp. For example, a shade mechanism, as taught in Patent Literature 6 or 7, may be used. The position of a shade (a shielding plate) of the shade mechanism is driven by the shade mechanism to switch among low-beam radiation, high-beam radiation, and middle high-beam radiation in each of the left headlamp 11L and the right headlamp 11R.

FIGS. 2 to 4 exemplify control modes for the radiation direction and the light distribution range of the headlamps 11 using the shade mechanisms. FIG. 2 illustrates the light distribution range 55 defined by the headlamps 11L and 11R when the left headlamp 11L and the right headlamp 11R of the vehicle 10 in which the vehicle headlamp light distribution control system 1 is mounted are both placed in the high-beam radiation mode.

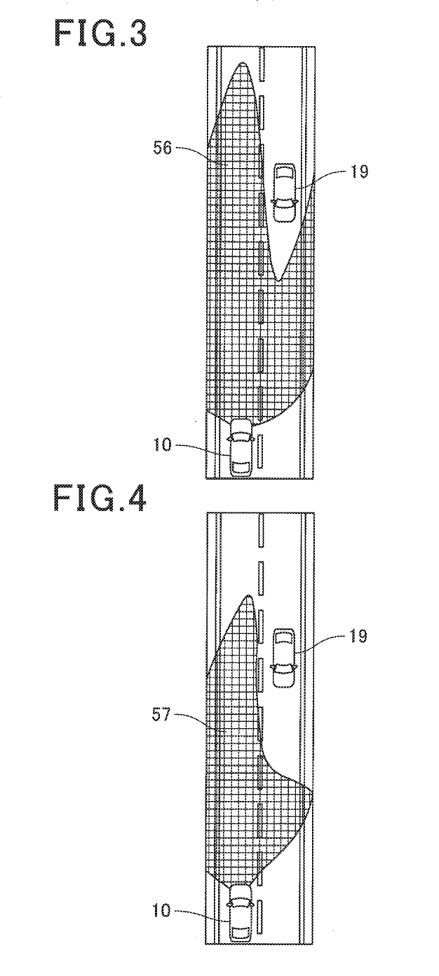

FIG. 3 illustrates the light distribution range 56 defined by the headlamps 11L and 11R when the left headlamp 11L and the right headlamp 11R are both placed in the middle high-beam radiation mode after the oncoming vehicle 19 is recognized.

FIG. 4 illustrates the light distribution range 57 defined by the headlamps 11L and 11R when the right headlamp 11R is placed in the low-beam radiation mode, while the left headlamp 11L is placed in the middle high-beam radiation mode.

In the right and left high-beam mode, as illustrated in FIG. 2, the shade mechanisms of the right and left headlamps 11R and 11L control the shades thereof so as to most widen the light distribution range.

In the right and left middle high-beam mode, as illustrated in FIG. 3, each of the shade mechanisms of the right and left headlamps 11R and 11L controls the position of the shade thereof so as to produce a light distribution range which blocks a portion of the light distribution range in the high-beam mode.

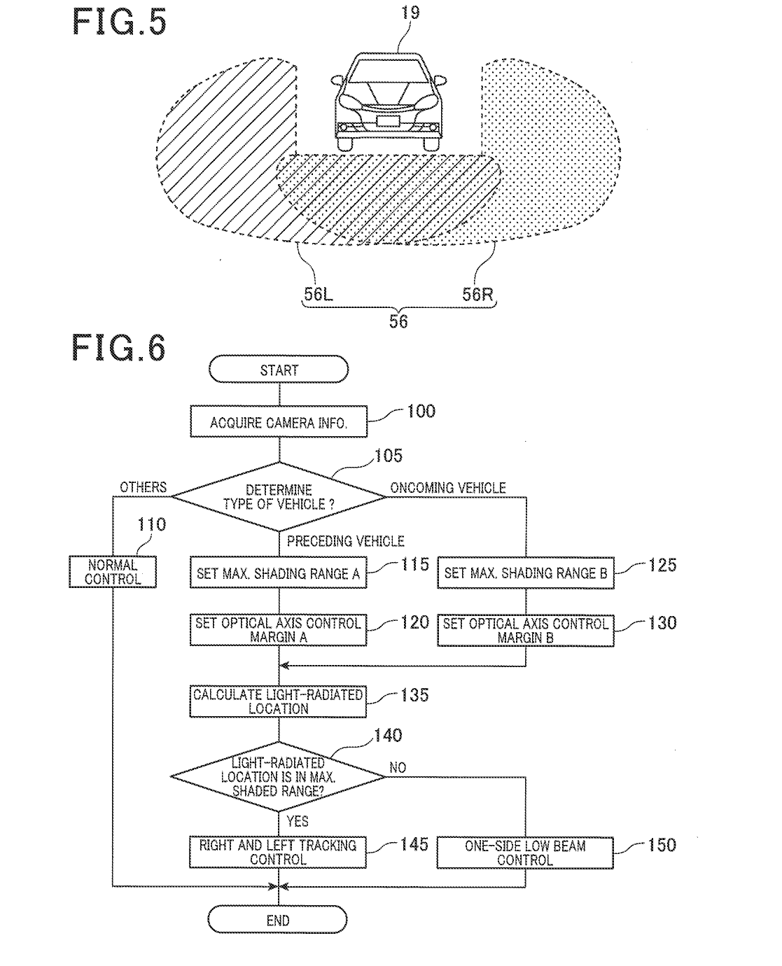

Specifically, as illustrated in FIG. 5 where the light distribution range of FIG. 3 is viewed from the vehicle 10, the position of the shade of the left headlamp 11L is controlled to partially block an upper right end of the light distribution range in the high-beam mode of the left headlamp 11L to leave the range 56L (an area hatched by diagonal lines).

Additionally, the position of the shade of the right headlamp 11R is controlled to partially block an upper left end of the light distribution range in the high-beam mode of the right headlamp 11R to leave the range 56R (an area hatched by dots).

In the middle high-beam mode, a portion of the light distribution range in the high-beam mode is, as described above, partially blocked to avoid dazzling the oncoming vehicle 19.

In the left middle high-beam/right low-beam mode, as illustrated in FIG. 4, the shade mechanism of the left headlamp 11 controls, like in FIG. 3, the shade, while the shade mechanism of the right headlamp 11 controls the position of the shade to produce a so-called low-beam light distribution range which is narrower than that in the middle high-beam mode. In this way, the right headlamp 11 is placed in the low-beam mode to block the light to the oncoming vehicle 19.

The headlamp drivers 13L and 13R control the respective shade mechanisms to switch the light radiation mode among the high-beam mode, the middle high-beam mode, and the low-beam mode, as described above, and also use the swivel motors thereof to change the radiation direction (i.e., the optical axis direction) of the headlamps 11L and 11R in the lateral direction of the vehicle, thereby controlling the light distribution range of both the headlamps 11.

The vehicle speed sensor 14 sequentially detects the speed of the vehicle 10 and outputs a vehicle speed signal indicative thereof to the ECU 16. The steering angle sensor 15 sequentially outputs a steered angle signal indicative of a steered angle of the vehicle to the ECU 16. The ECU 16 calculates a steered angle of the system-mounted vehicle based on the steered angle signal.

The ECU 16 (the vehicle headlamp light distribution control apparatus) is an electronic control device equipped with a microcomputer. The ECU 16 runs a program stored therein to execute a given task for controlling the light distribution range of the headlamps 11.

The operation of the thus constructed vehicle headlamp light distribution control system 1 when the headlamps 11L and 11R are lighted (e.g., at night or upon passing through a tunnel) will be described below. When the headlamps 11L and 11R are lit, the ECU 16 repeats the processing, as illustrated in FIG. 6, at an interval of, for example, 1/30 sec.

In step 100, the ECU 16 first detects the vehicle speed. Specifically, the latest camera information is acquired from the image sensor 12.

Subsequently, in step 105, the type of a forward vehicle traveling ahead of the vehicle 10 is identified based on the acquired camera information. Specifically, pieces of preceding/oncoming vehicle information about a leftmost light source and a rightmost light source are read out of information (i.e., the positional coordinates and the pieces of preceding/oncoming vehicle information) about the respective acquired light sources.

When both the leftmost light source and the rightmost light source are determined to be light sources of a preceding vehicle based on the two read pieces of preceding/oncoming vehicle information, it is determined that a preceding vehicle is in front of the vehicle 10. The routine then proceed to step 115. Alternatively, if a NO answer is obtained, the routine proceeds to step 110.

For instance, when no vehicle is present in front of the vehicle 10, there will not be the leftmost light source and the rightmost light source. The routine then proceeds to step 110 wherein normal headlamp control is performed. Specifically, the headlamp drivers 13L and 13R are set to the right and left high-beam mode, as illustrated in FIG. 2, to orient locations light-distributed by the headlamps 11L and 11R (i.e., the optical axes thereof) in a straight running direction of the vehicle 10.

Alternatively, in step 110, the location where the vehicle 10 is expected to exist three seconds later may be calculated based on signals derived from the vehicle speed sensor 14 and the steering angle sensor 15 to control the headlamp drivers 13L and 13R so as to orient the light radiated from the headlamps 11L and 11R (i.e., the optical axes thereof) to the calculated vehicle location. After step 110, the program of FIG. 6 terminates.

Alternatively, when there is only one preceding vehicle in front of the vehicle 10, only information about light sources corresponding to two tail lamps of the preceding vehicle (i.e., the positional coordinates and the preceding/oncoming vehicle information) is acquired in step 100. Therefore, in step 105, the leftmost light source and the rightmost light source are both determined to be the light sources of the preceding vehicle in step 105. The routine then proceeds to step 115.

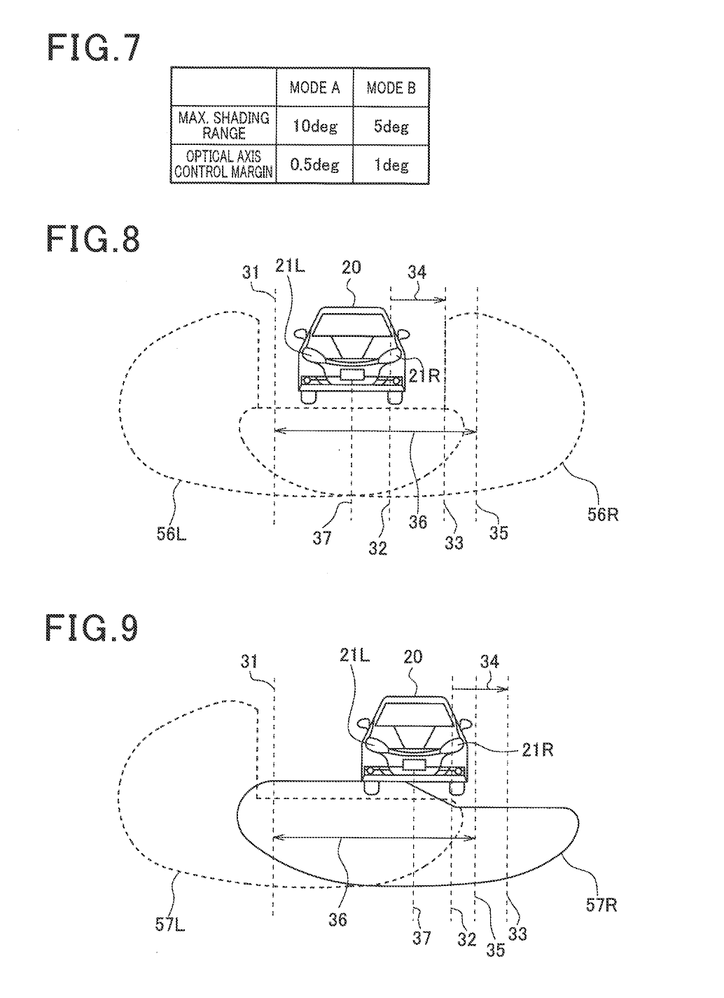

In step 115, a value (10°) in the light distribution mode A in FIG. 7 is adopted as a maximum shading range. In step 120, a value (0.5°) in the light distribution mode A of FIG. 7 is selected as an optical axis control margin.

Alternatively, when there is only one oncoming vehicle in front of the vehicle 10, only information about light sources corresponding to two headlamps of the oncoming vehicle (i.e., the positional coordinates and the preceding/oncoming vehicle information) is acquired in step 100. Therefore, in step 105, the leftmost light source and the rightmost light source are both determined to be light sources of the oncoming vehicle in step 105. The routine then proceeds to step 125.

In step 125, a value (5°) in the light distribution mode B in FIG. 7 is adopted as the maximum shading range. In step 130, a value (1°) in the light distribution mode B of FIG. 7 is selected as the optical axis control margin.

The maximum shading range and the optical axis control margin will be described below using FIG. 8. The ranges 56L and 56R in FIG. 8 are light distribution ranges of the headlamps 11L and 11R in the middle high-beam mode, respectively. The range 56 that is the sum of the ranges 56L and 56R is a light distribution range in the right and left middle high-beam mode.

“31” indicates the controlled center corresponding to the front position of the vehicle 10. The controlled center 31 is, therefore, a position fixed in the captured image (i.e., a position fixed in the running direction of the vehicle 10). “32” indicates a position of the rightmost light source 21R in the lateral direction. In a typical case, right and left headlamps (headlamps or tail lamps) of the forward vehicle 20 correspond to the leftmost light source 21L and the rightmost light source 21R.

“33” indicates a light-radiated location (i.e., the optical axis direction) and is a right cut-off line. The right cut-off line 33 is a right end of a range light-blocked by the shade of the right headlamp 11R and also a boundary between the right headlamp 11R and such a shaded range. Specifically, the light distribution range of the right headlamp 11R is controlled using the shade to block the light on the left side of the right cut-off line 33.

The range 34 from the position 32 of the right light source 21 R to the right cut-off line 33 (i.e., an angular range, as viewed from the vehicle 10) is the optical axis control margin for the right headlamp 11R. When there is a forward vehicle (a preceding vehicle or an oncoming vehicle), the optical axis and the shade are, as described later, controlled so that the forward vehicle may fall in a range light-blocked by the shade using the middle high-beam.

It usually takes a certain amount of time for detection of positions of the rightmost light source and the leftmost light source (corresponding to a reference position of the forward vehicle), determination of a shaded range as a function of the detected position, and the operation of the actuators according to the determined shaded range. This results in a possibility of a lag in making an actually shaded range track the movement of the forward vehicle which should be shaded when it moves fast.

In order to prevent the light from irradiating a forward vehicle which has moved outside a shaded range when the actual center of the forward vehicle is shifted out of alignment with that of the forward vehicle due to the lag of the shaded range tracking the forward vehicle, the above described optical axis control margin 34 is set. The optical axis control margin is a margin of the shaded range in the lateral direction for the tracking lag.

The movement of the forward vehicle out of the shaded range due to an increase in influence resulting from the tracking lag occurs, for example, when the velocity at which the forward vehicle moves in the lateral direction greatly increases in an image captured by the image sensor 12.

The vehicle headlamp light distribution control system 1 defines the cut-off line 33, as described above, shifted to the right from the rightmost light source 21R by the optical axis control margin 34. However, when the forward vehicle 20, as demonstrated in FIG. 9, has moved greatly to the right out of the controlled center 31, so that the location 33, as shifted from the rightmost light source 21R to the right by the optical axis control margin 3, has moved outside the cut-off limit position 35 to the right, the vehicle headlamp light distribution control system 1 works to stop the right headlamp 11R from making the cut-off line track the rightmost light source 21 R in the middle high-beam mode and place it in the low-beam mode.

The reason for the above is because when the forward vehicle has moved greatly to the right, the possibility that the forward vehicle is very close to the vehicle 10 is high, which results in a high possibility that the velocity at which the forward vehicle moves in the captured image is very high, so that the lag in tracking the shaded range increases.

In the above way, the control mode of the right headlamp 11R (i.e., whether the middle high-beam of the rightmost light source 21R should be made to track the cut-off or not) is changed according to a positional relation between the location 33 shifted to the right from the rightmost light source 21R by the optical axis control margin 34 and the cut-off limit position 35. The cut-off limit position 35 is determined by setting the maximum shading range 36 that is a range (i.e., an angular range) between the controlled center 31 and the cut-off limit position 35.

The above discussion has referred to the cut-off line 33, the optical axis control margin 34, the cut-off limit position 35, and the maximum shading range 36, however, the cut-off line and the optical axis control margin of the left headlamp 11L are set to be symmetrical with those of the right headlamp 11R about the vehicle center 37 located at equal distances away from the leftmost light source 21L and the rightmost light source 21R.

Specifically, the optical axis control margin of the leftmost headlamp 11L is a range (i.e., angular range, as viewed from the vehicle 10) between the position of the leftmost light source 21L and the cut-off line (i.e., the light-radiated location in this embodiment) of the left headlamp 11L. The maximum shading range of the left headlamp 11L is a range (i.e., an angular range) between the controlled center 31 and the cut-off limit position of the left headlamp 11L. The light distribution range of the left headlamp 11L is controlled to shade the right side of the left cut-off line using the shade.

In this embodiment, values of the optical axis control margin and the maximum shading range of the left headlamp 11L are identical with those of the right headlamp 11R, however, they may be different between the right and left headlamps 11R and 11L.

After step 120, the routine proceeds to step 135 wherein the light-radiated locations (i.e., the cut-off lines) of the right and left headlamps 11R and 11L are calculated. Specifically, the location shifted to the left from the leftmost light source 21L by the optical axis control margin is defined as the light-radiated location (i.e., the cut-off line) of the left headlamp 11L. The location shifted to the right from the rightmost light source 21R by the optical axis control margin is defined as the light-radiated location (i.e., the cut-off line) of the right headlamp 11R.

In the following step 140, it is determined whether the light-radiated location (i.e., the cut-off line), as determined in step 135, lies within the maximum shading range or not. However, when the above described vehicle center 37 is on the left side of the controlled center 31, the above determination is made with respect to the light-radiated location (i.e., the cut-off line) and the maximum shading range of only the left headlamp 11L. Alternatively, when the vehicle center 37 is on the right side of the controlled center 31, the above determination is made with respect to the light-radiated location (i.e., the cut-off line) and the maximum shading range of only the right headlamp 11R.

Therefore, in the case where the vehicle center 37 is on the right side of the control sensor 31, when the cut-off limit position 35 of the right headlamp 11R is located at the same position as the cut-off line 33 or on the right side of the cut-off line 33, the light-radiated location (i.e., the cut-off line) is determined to lie in the maximum shading range. Alternatively, when the cut-off limit position 35 of the right headlamp 11R is located on the left side of the cut-off line 33, the light-radiated location (i.e., the cut-off line) is determined not to lie in the maximum shading range.

Alternatively, in the case where the vehicle center 37 is on the left side of the control sensor 31, when the cut-off limit position of the left headlamp 11L is located at the same position as the cut-off line or on the left side of the cut-off line, the light-radiated location (i.e., the cut-off line) is determined to lie in the maximum shading range. Alternatively, when the cut-off limit position is located on the right side of the cut-off line, the light-radiated location (i.e., the cut-off line) is determined not to lie in the maximum shading range.

If the light-radiated location (i.e., the cut-off line) is determined to lie within the maximum shading range, the routine proceeds to step 145. Alternatively, if it is determined not to lie in the maximum shading range, the routine proceeds to step 150.

In step 145, the right and left tracking control is, as described already, made. Specifically, the swivel motor of the left headlamp driver 13L is controlled to orient the optical axis direction of the left headlamp 11L to the light-radiated location of the left headlamp 11L. The swivel motor of the right headlamp driver 13R is controlled to orient the optical axis direction of the right headlamp 11R to the light-radiated location of the right headlamp 11R. Additionally, the shade mechanism motors of the headlamp drivers 13L and 13R are controlled to achieve the right and left middle high-beam mode, as illustrated in FIGS. 3 and 8.

In step 145, the optical axis control margin, as set in step 120 or step 130 in this cycle of the program of FIG. 6, is used for the right and left headlamps 11R and 11L.

In the above way, the vehicle 10 swivels the headlamps 11L and 11R laterally according to the lateral location of the forward vehicle (i.e., the preceding vehicle or the oncoming vehicle), thereby avoiding dazzling the forward vehicle, while enhancing the visibility around the forward vehicle. After step 145, the program of FIG. 6 terminates.

Alternatively, in step 150, one-side low-beam control is performed. Specifically, when the vehicle center 37 is on the right side of the controlled center 31, the shade mechanism motor of the right headlamp driver 13R is, as illustrated in FIGS. 4 and 9, controlled to place the light, as distributed from the right headlamp 11R, in the low-beam mode. Additionally, the shade mechanism motor of the left headlamp driver 13L is controlled to place the light, as distributed from the left headlamp 11L, in the middle high-beam mode.

Further, the optical axis direction (i.e., the cut-off line) of the left headlamp 11L is, as shown in FIG. 9, oriented to a location shifted to the left from the controlled center 31 (or a location at which the vehicle 10 is expected to lie three seconds later as a function of the steered angle and the vehicle speed) by a given distance, while the optical axis direction (i.e., the cut-off line) of the right headlamp 11R is oriented to a location shifted to the right from the controlled center 31 (or the location at which the vehicle 10 is expected to lie three seconds later as a function of the steered angle and the vehicle speed) by a given distance. In other words, neither the left headlamp 11L nor the right headlamp 11R perform the swivel control to track the forward vehicle.

Alternatively, when the vehicle center 37 is on the left side of the controlled center 31, the shade mechanism motor of the left headlamp driver 13L is controlled to place the light, as distributed from the left headlamp 11L, in the low-beam mode. Additionally, the shade mechanism motor of the right headlamp driver 13R is controlled to place the light, as distributed from the right headlamp 11R, in the middle high-beam mode.

Further, the optical axis direction (i.e., the cut-off line) of the right headlamp 11R is, as shown in FIG. 9, oriented to a location shifted to the right from the controlled center 31 (or a location at which the vehicle 10 is expected to lie three seconds later as a function of the steered angle and the vehicle speed) by the given distance, while the optical axis direction (i.e., the cut-off line) of the left headlamp 11L is oriented to a location shifted to the left from the controlled center 31 (or the location at which the vehicle 10 is expected to lie three seconds later as a function of the steered angle and the vehicle speed) by the given distance. In other words, neither the left headlamp 11L nor the right headlamp 11R perform the swivel control to track the forward vehicle. After step 150, the program of FIG. 6 terminates.

When only one forward vehicle (i.e., a preceding vehicle or an oncoming vehicle) is coming close to the vehicle 10 from the forward left side or the forward right side on a straight road at night, the ECU 16 repeats the above described program of FIG. 6 to first select the maximum shading range and the optical axis control margin in steps 115 and 120 or steps 125 and 130 depending upon whether the forward vehicle is the preceding vehicle or the oncoming vehicle while the forward vehicle is far away from the vehicle 10.

Since the forward vehicle is still far away from the vehicle 10, it is not far from the controlled center 31, so that the light-radiated location, as calculated in step 135, lies within the maximum shading range. The light-radiated location is, therefore, determined to be within the maximum shading range in step 140. The routine then proceeds to step 145 to perform the above described right and left tracking control.

As apparent from the above, when the forward vehicle is far away from the vehicle 10, the program of FIG. 6 is repeated to make the optical axis directions of the right and left headlamps 11R and 11L track the forward vehicle with a change in lateral location of the forward vehicle relative to the vehicle 10 and also to avoid dazzling the forward vehicle in the right and left middle high-beam mode.

When the forward vehicle comes close to the vehicle 10, so that the light-radiated location, as calculated in step 135, lies out of the maximum shading range, the light-radiated location is determined to be outside the maximum shading range in step 140, the routine proceeds to step 150 wherein the above described one-side low-beam control is performed. This terminates the tracking control to track the forward vehicle with the right and left middle high-beams.

The difference in the above control between when the forward vehicle is a preceding vehicle and when the forward vehicle is an oncoming vehicle will be explained below. First, the optical axis control margin (1°) when the forward vehicle is the oncoming vehicle is set greater than that (0.5°) when the forward vehicle is the preceding vehicle.

The reason for the above is because the oncoming vehicle is usually higher in relative speed to the vehicle 10 than the preceding vehicle, so that the lateral velocity of the oncoming vehicle relative to the vehicle 10 is higher than that of the preceding vehicle, thus resulting in an increase in influence resulting from the lag in tracking the shaded range. In other words, in the case where the forward vehicle is the preceding vehicle, the adverse effect arising from the lag in tracking the shaded range is relatively small. There is, therefore, a low possibility that the preceding vehicle moves out of the shaded range blocked by the shade even if the optical axis control margin is decreased to widen the light distribution range.

In the above way, the optical axis control margin is changed depending upon whether the forward vehicle is the preceding vehicle or the oncoming vehicle, thereby avoiding dazzling the forward vehicle and also optimizing the forward visibility depending upon the type of the forward vehicle.

Next, the difference in the maximum shading range between when the forward vehicle is a preceding vehicle and when the forward vehicle is an oncoming vehicle will be explained below. First, the maximum shading range (5°) when the forward vehicle is the oncoming vehicle is set smaller than that (10°) when the forward vehicle is the preceding vehicle.

The reason for the above is because the influence on the oncoming vehicle which results from the lag in tracking the shaded range is higher than that on the preceding vehicle. In other words, when the forward vehicle is the preceding vehicle, the effect arising from the lag in tracking the shaded range is lower, thereby resulting in a low possibility that the preceding vehicle moves out of the shaded range blocked by the shade when the right and left tracking control using the right and left middle high-beams continues over a wider range.

In the above way, the maximum shading range is changed depending upon whether the forward vehicle is the preceding vehicle or the oncoming vehicle, thereby avoiding dazzling the forward vehicle and also optimizing the forward visibility depending upon the type of the forward vehicle.

### Second Embodiment

Next, the second embodiment of the invention will be described. This embodiment is different from the first embodiment in how the maximum shading range and the optical axis control margin are determined. The vehicle headlamp light distribution control system 1 of this embodiment is identical in hardware structure with that of the first embodiment.

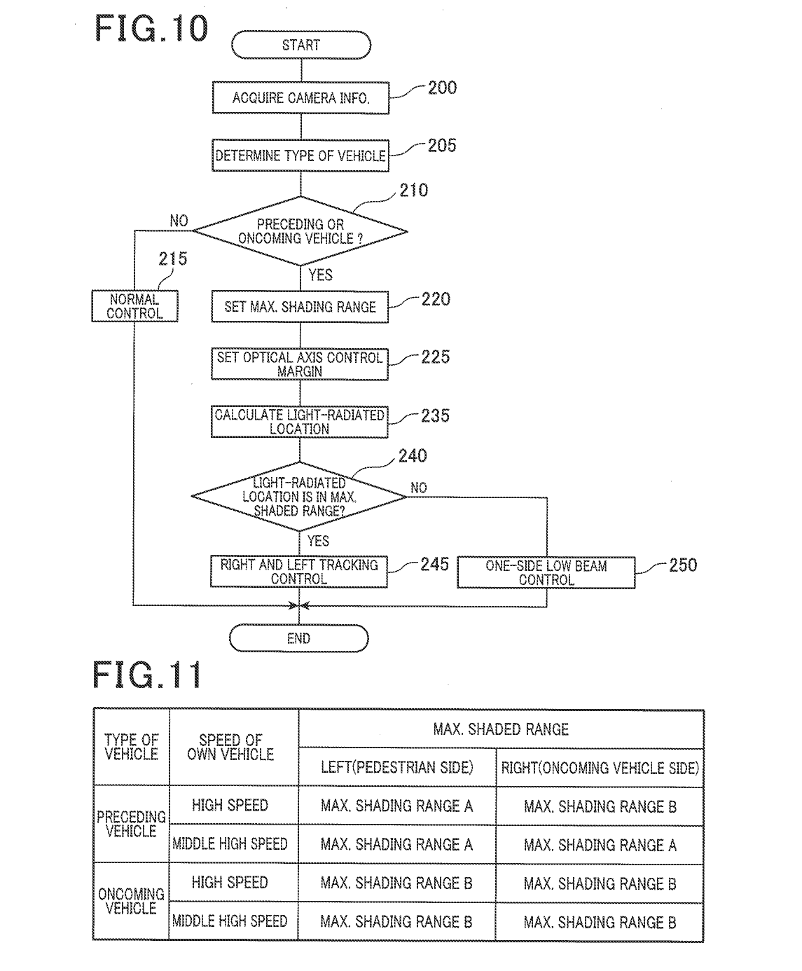

The ECU 16 of this embodiment is engineered to execute a program of FIG. 10 repeatedly instead of the light distribution control program of FIG. 6. The program of FIG. 10 will be described below. When the headlamps 11L and 11R are lit, the ECU 16 performs the program of FIG. 10 repeatedly (e.g., cyclically at an interval of 1/30 sec.).

First, in step 200, the ECU 16 performs vehicle detection. Specifically, the ECU 16 acquires latest camera information from the image sensor 12.

Subsequently, in step 205, the type of a forward vehicle traveling ahead of the vehicle 10 is identified based on the acquired camera information. The way of such identification is the same as that in step 105 of FIG. 6. This vehicle type identification is to determine whether a preceding vehicle is present ahead of the vehicle 10, an oncoming vehicle is present ahead of the vehicle 10, or neither are present ahead of the vehicle 10.

In the following step 210, it is determined based on the results of determination in step 205 whether the preceding vehicle or the oncoming vehicle is in front of the vehicle 10 or not. When the preceding vehicle or the oncoming vehicle is present ahead of the vehicle 10, the routine proceeds to step 220. If not, then the routine proceeds to step 215.

For instance, when there is no vehicle ahead of the vehicle 10, there is no leftmost light source or rightmost light source. The routine then proceeds to step 215 wherein normal headlamp control is performed in the same way as in step 110 of FIG. 6. After step 215, the light distribution control program of FIG. 10 terminates.

In step 220, the maximum shading range is defined based on the result of the vehicle type identification in step 205. This definition is achieved by a definition matrix of the maximum shading range, as illustrated in FIG. 11. It is assumed in this embodiment that vehicles are running on the left of a road. Therefore, the left side of the vehicle 10 is a pedestrian's side, while the right side of the vehicle 10 is an oncoming vehicle's side.

Specifically, when it is determined in step 205 that the preceding vehicle is present ahead of the vehicle 10, a current speed of the vehicle 10 is determined based on the signal from the vehicle speed sensor 14.

When the determined vehicle speed is a speed higher than or equal to a reference speed (e.g., 80 km/hour), the maximum shading range of the left headlamp 11L is set to a range of the high distribution mode A. Additionally, the maximum shading range of the right headlamp 11R is set to a range of the light distribution mode B. Alternatively, when the determined vehicle speed is a middle-low speed less than the reference speed, the shaded ranges of both the left headlamp 11L and the right headlamp 11R are set to the range of the light distribution mode A.

When it is determined in step 205 that there is an oncoming vehicle in front of the vehicle 10, the maximum shading ranges of the left headlamp 11L and the right headlamp 11R are set to the range of the light distribution mode B regardless of the speed of the system-mounted vehicle. The maximum shading ranges of the light distribution modes A and B are the same as illustrated in FIG. 7 in the first embodiment.

As already discussed in the first embodiment, there is a low possibility that the influence on the maximum shading range (10°) of the light distribution mode A which results from the lag in tracking the shaded range greatly increases. The maximum shading range (10°) is, therefore, used when it is required to continue the right and left tracking control over a wider range. There is a high possibility that the influence on the maximum shading range (5°) of the light distribution mode B which results from the lag in tracking the shaded range greatly increases. The maximum shading range (5°) is, therefore, used when it is required to terminate the right and left tracking control relatively early.

In the example of FIG. 11, when the forward vehicle is the oncoming vehicle, the maximum shading ranges of the left headlamp 11L and the right headlamp 11R are both set relatively narrow.

The reason why the maximum shading range is set relatively small is because the oncoming vehicle is usually higher in relative speed to the vehicle 10 than the preceding vehicle, thus resulting in a high possibility that the effect on the oncoming vehicle which arises from the lag in tracking the shaded range increases.

Alternatively, in the case where the forward vehicle is the preceding vehicle, the maximum shading range of the right headlamp 11R (closer to the oncoming vehicle) is set relatively small only when the speed of the vehicle 10 is high. This is to limit the tracking control for alleviating the burden on the driver because assuming running on an expressway, the number of times oncoming vehicles are passed is relatively high.

In the following step 225, the optical axis control margin is defined based on the result of the vehicle type determination in step 205.

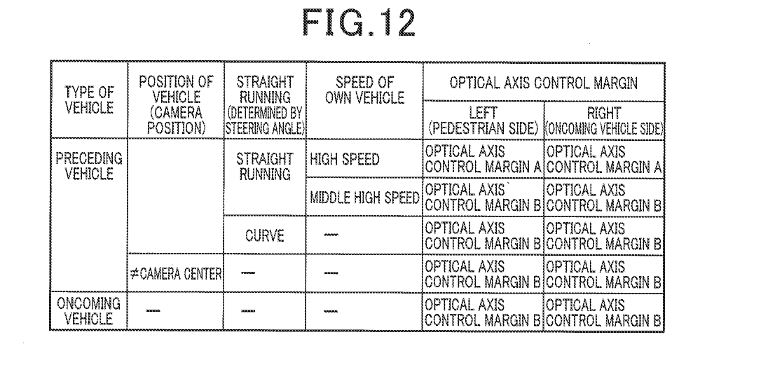

This definition is achieved by a definition matrix of the optical axis control margin matrix, as illustrated in FIG. 12. The same light distribution modes A and B as those in FIG. 7 in the first embodiment are used.

Specifically, when it is determined in step 205 that the preceding vehicle is present ahead of the vehicle 10, positional coordinates of the leftmost light source and positional coordinates of the rightmost light source, as derived in step 200, are sampled to determine coordinates of a location equal distances away from the two sampled sets of the positional coordinates as vehicle positional coordinates.

It is then determined whether the vehicle positional coordinates lie within a given distance (e.g., 2°) from a center line which equally divides the captured image into a right and a left section, that is, whether the vehicle positional coordinates lie in front of the vehicle 10 or not. When the vehicle positional coordinates lie within the given distance, the preceding vehicle is determined to be on the center of the camera. Alternatively, when the vehicle positional coordinates lie out of the given distance, the preceding vehicle is determined not to be on the center of the camera.

In the case where the preceding vehicle is determined to be on the center of the camera, it is determined whether the vehicle 10 is traveling straight or not based on the signal from the steering sensor 15. When the vehicle 10 is determined to be running straight, a current speed of the vehicle 10 is determined based on the signal from the vehicle speed sensor 14.

When the determined vehicle speed is a speed higher than or equal to a reference speed (e.g., 80 km/hour), the optical axis control margins of the left headlamp 11L and the right headlamp 11R are set to a value (0.5°) in the high distribution mode A. Alternatively, when the determined vehicle speed is a middle-low speed less than the reference speed, the optical axis control margins of the left headlamp 11L and the right headlamp 11R are set to a value (1°) in the high distribution mode B.

When it is determined that the vehicle 10 is not traveling straight, that is, that the vehicle 10 is running on a curve, the optical axis control margins of the left headlamp 11L and the right headlamp 11R are set in the high distribution mode B.

The reason why the optical axis control margin is set relatively small when the vehicle 10 is traveling at a high speed, while it is set relatively great when the vehicle 10 is traveling at a middle-low speed is because the distance between the vehicle 10 and the preceding vehicle during running in the middle-low speed is shorter than that during running in the high speed, and the radius of turn of the preceding vehicle or the vehicle 10 during running in the middle-low speed becomes smaller than that during running in the high speed, so that there is a high possibility that the angular velocity of the preceding vehicle relative to the vehicle 10 in the lateral direction increases, thus resulting in a high possibility that the effect arising from the lag in tracking the shaded range increases.

The reason why the optical axis control margin is set relatively great while the vehicle 10 is running on a curve regardless of the running state of the vehicle 10 is because the speed at which the preceding vehicle moves relative to the vehicle 10 in the lateral direction is often high, thus resulting in a low possibility that the effect on the preceding vehicle which results from the lag in tracking the shaded range increases even when the speed of the vehicle 10 is low.

When it is determined that the preceding vehicle is not in front of the center of the camera, the optical axis control margins of the left headlamp 11L and the right headlamp 11R are set in the high distribution mode B regardless of whether the vehicle 10 is running straight or not and the speed of the vehicle 10.

The reason why when the preceding vehicle is out of the center of the captured image (i.e., the center or the camera), the optical axis control margins are set relatively great regardless of the running state of the vehicle 10 is because the more the preceding vehicle is shifted from the center in the lateral direction, the higher the possibility that the preceding vehicle is approaching the vehicle 10. In such a case, the speed at which the preceding vehicle moves relative to the vehicle 10 in the lateral direction is often high, thus resulting in a high possibility that the effect on the preceding vehicle which arises from the lag in tracking the shaded range regardless of a straight road, a curved road, or a low speed of the vehicle 10.

Alternatively, when it is determined in step 205 that the oncoming vehicle is in front of the vehicle 10, the optical axis control margins of the left headlamp 11L and the right headlamp 11R are set in the high distribution mode B regardless of whether the oncoming vehicle is positioned on the center of the camera or not, or the vehicle 10 is running straight or not, or the speed of the vehicle 10.

The reason why the optical axis control margins are set relatively great for the oncoming vehicle at all times is because the relative speed of the oncoming vehicle to the vehicle 10 is higher than that of the preceding vehicle, thus resulting in a high possibility that the effect on the oncoming vehicle which results from the lag in tracking the shaded range increases even when the speed of the vehicle 10 is low.

In the following step 235, the light-radiated locations (i.e., the cut-off lines) of the right and left headlamps 11R and 11L are calculated in the same way as in step 135 of FIG. 6. In step 240, it is determined in the same way as in step 140 of FIG. 6 whether the light-radiated locations (i.e., the cut-off lines), as derived in step 235, lie in the maximum shading range or not.

When it is determined that the light-radiated locations (i.e., the cut-off lines) lie in the maximum shading range, the routine proceeds to step 245. Alternatively, when it is determined that the light-radiated locations (i.e., the cut-off lines) lie out of the maximum shading range, then the routine proceeds to step 250.

In step 245, the above described right and left tracking control is performed in the same way as in step 145 of FIG. 6. The vehicle 10, therefore, swivels the headlamps 11L and 11R in the middle high-beam mode to the left and right according to a lateral position of the forward vehicle (i.e., the preceding vehicle or the oncoming vehicle), thus avoiding dazzling the forward vehicle as well as enhancing the visibility around the forward vehicle. After step 245, the light distribution control program of FIG. 10 terminates.

In step 250, the one-side low-beam control is performed in the same way as in step 150 of FIG. 6. After step 250, one cycle of the processing in FIG. 10 terminates.

When only one forward vehicle (i.e., a preceding vehicle or an oncoming vehicle) is coming close to the vehicle 10 from the forward left side or the forward right side on a straight road at night, the ECU 16 repeats the above described program of FIG. 10 to first select the maximum shading range and the optical axis control margin in steps 220 and 225 depending upon whether the forward vehicle is the preceding vehicle or the oncoming vehicle while the forward vehicle is far away from the vehicle 10.

Since the forward vehicle is still far from the vehicle 10, it is not far away from the controlled center 31, so that the light-radiated location, as calculated in step 235, lies within the maximum shading range. The light-radiated location is, therefore, determined to be within the maximum shading range in step 240. The routine then proceeds to step 245 to perform the above described right and left tracking control.

As apparent from the above, when the forward vehicle is far from the vehicle 10, the program of FIG. 10 is repeated to make the optical axis directions of the right and left headlamps 11R and 11L track the forward vehicle with a change in lateral location of the forward vehicle relative to the vehicle 10 and also to avoid dazzling the forward vehicle in the right and left middle high-beam mode.

When the forward vehicle approaches the vehicle 10, so that the light-radiated location, as derived in step 235, falls out of the maximum shading range, it is determined in step 240 that the light-radiated location is out of the maximum shading range. The routine then proceeds to step 250 wherein the above described one-side low-beam control is performed. This terminates the tracking control for the forward vehicle in the right and left middle high-beam mode.

### Other Embodiments

The embodiments of the invention have been described above, but the scope of the invention is not limited to the above embodiments. The invention includes all possible combinations of modifications of the above embodiments. For instance, the following modifications may be made.

(1) In the above embodiments, the light-radiated location (i.e., the optical axis direction) and the cut-off line 33 are at the same position, however, they are not necessarily at the same position.
(2) In the above embodiments, the image sensor 12 outputs the preceding/oncoming vehicle information about positional coordinates of each of a plurality of light sources in front of the vehicle 10 and whether each light source is a light source of the preceding vehicle or the oncoming vehicle as the camera information. The ECU 16 acquires the camera information in steps 100 and 200.

The positional coordinates of a plurality of light sources in front of the vehicle 10 are an example of a marked position (i.e., the position of a headlamp or a tail lamp) of the forward vehicle. The ECU 16 is capable of using the preceding/oncoming vehicle information indicating whether the light source is a light source of the preceding vehicle or the oncoming vehicle to determine whether a forward vehicle is the preceding vehicle or an oncoming vehicle.

The image sensor 12 may, however, detect positions of right and left sides of the forward vehicle on the captured image through the image analysis, determine whether the forward vehicle is the oncoming vehicle or the preceding vehicle based on whether a steering wheel is on the captured image or not, and output the preceding/oncoming vehicle information indicating the positional coordinates of the right and left ends of the forward vehicle and whether the forward vehicle is the preceding vehicle or the oncoming vehicle as the camera information. The ECU 16 may acquire such camera information in steps 100 and 200. In this case, the right and left ends of the forward vehicle are a marked position of the forward vehicle.

Instead of the image sensor 12, a sensor may alternatively be used which communicates with a device (e.g., an on-road device) external to the vehicle 10, receives the preceding/oncoming vehicle information about the positional coordinates of the right and left ends of the forward vehicle and whether the forward vehicle is the preceding vehicle or the oncoming vehicle, and then outputs the received information to the ECU 16.

Specifically, the image sensor 12 or its alternative sensor may be a sensor which works to output information for specifying positional coordinates of the marked position of a forward vehicle running ahead of the vehicle 10 and determining whether the forward vehicle is a preceding vehicle or an oncoming vehicle. The ECU 16 may be designed to acquire such information.

(3) The second embodiment, as illustrated in FIG. 12, changes the optical axis control margin depending on whether the forward vehicle is in the front of the vehicle 10 or not only when the forward vehicle is a preceding vehicle. It is, however, not essential. The optical axis control margin may be changed depending on whether the forward vehicle is present in front of the vehicle 10 or not regardless of whether the forward vehicle is the preceding vehicle or not.
(4) The second embodiment, as illustrated in FIG. 12, also changes the optical axis control margin depending on whether the vehicle 10 is running straight or not only when the forward vehicle is a preceding vehicle and exists in front of the vehicle 10. It is, however, not essential.

The optical axis control margin may be changed depending on whether the vehicle 10 is running straight or not regardless of whether the forward vehicle is a preceding vehicle or not and whether the forward vehicle exists in front of the vehicle 10 or not.

(5) The second embodiment, as illustrated in FIG. 12, also changes the optical axis control margin as a function of the speed of the vehicle 10 only when the forward vehicle is a preceding vehicle and exists in front of the vehicle 10, and the vehicle 10 is running straight. It is, however, not essential. The optical axis control margin may be changed as a function of the speed of the vehicle 10 regardless of whether the forward vehicle is a preceding vehicle or not, and exists in front of the vehicle 10 or not, and the vehicle 10 is running straight or not.
(6) The second embodiment, as illustrated in FIG. 11, also changes the maximum shading range as a function of the speed of the vehicle 10 only when the forward vehicle is a preceding vehicle. It is, however, not essential. The maximum shading range may be changed as a function of the speed of the vehicle 10 regardless of whether the forward vehicle is a preceding vehicle or not.
(7) The above embodiments use a combination of the vehicle speed sensor and the steering angle sensor as a behavior sensor to measure the behavior of the vehicle 10, however, the behavior sensor may be implemented by another combination (e.g., the vehicle speed sensor and a yaw rate sensor) as long as it is capable of measuring the above change in angle η of the vehicle 10.
(8) The above embodiments use the image sensor 12 which captures a forward view in front of the vehicle 10 to output the camera information (corresponding to positional information about the forward vehicle) as a forward position sensor which detects a forward condition of the vehicle 10 to output information about the position of the forward vehicle. However, as the forward position sensor instead of the image sensor 12, a laser radar sensor may be employed which emits a laser forward from the vehicle 10 and detects its reflected wave to output the positional information about the forward vehicle.
(9) In the above embodiments, the headlamp drivers 13L and 13R may also be equipped with a leveling motor for adjusting a vertical direction of the light distribution ranges of the headlamps 11L and 11R in addition to the swivel motor. The ECU 16 may be engineered to control the leveling motors as needed.
(10) In the above embodiments, each of the headlamps 11L and 11R is equipped with only a single light emitter which produces the high-beam, the middle high-beam, and the low-beam. It is, however, not essential. For instance, each of the headlamps 11L and 11R may have a single light emitter working to create the high-beam and the middle-high beam and a single additional light emitter working to produce the low-beam.

Alternatively, each of the headlamps 11L and 11R may be designed to have a plurality of light emitters (e.g., 10,000 light emitters arranged in a 100×100 matrix) and control on and off operations thereof independently from each other to selectively create the high-beam, the middle high-beam, and the low-beam.

(11) The ECU 16 works to control the optical axis direction of the headlamps 11L and 11R to track a location on which the marked position (i.e., the leftmost light source or the rightmost light source) of the forward vehicle is based. It is, however, not essential.

For instance, the ECU 16 may be designed to change only the cut-off lines based on the marked position of the forward vehicle without changing the optical axis directions of the headlamps 11L and 11R.

### REFERENCE SIGN LIST

11L left headlamp
1R right headlamp
31 controlled center
34 right optical axis control margin
35 right cut-off limit position
36 right maximum shading range

What is claimed is:

1. A vehicle headlamp light distribution control apparatus which controls a light distribution of a headlamp of a vehicle, comprising:
acquiring means for acquiring preceding/oncoming vehicle information for specifying positional coordinates that are a marked position of a forward vehicle running in front of said vehicle and determining whether the forward vehicle is a preceding vehicle or an oncoming vehicle;
vehicle type determining means for determining a type of said forward vehicle based on the preceding/oncoming vehicle information, as acquired by said acquiring means;
optical axis control margin setting means for setting an optical axis control margin based on a result of determination made by said vehicle type determining means, said optical axis control margin setting means setting the optical axis control margin when said vehicle type determining means determines that the oncoming vehicle is in front of said vehicle to be greater than that when said vehicle type determining means determines that the preceding vehicle is in front of said vehicle;
cut-off line calculating means for, when said headlamp is a left headlamp, defining a location shifted from the positional coordinates of said marked position to the left by said optical axis control margin as a cut-off line of the left headlamp or, when said headlamp is a right headlamp, defining a location shifted from the positional coordinates of said marked position to the right by said optical axis control margin as a cut-off line of the right headlamp based on the positional coordinates of the marked position of said forward vehicle, as acquired by said acquiring means; and
control means for, when said headlamp is the left headlamp, controlling a light-distribution range of the left headlamp so as to shade a right side of said cut-off line or, when said headlamp is the right headlamp, controlling a light distribution range of the right headlamp so as to shade a left side of said cut-off line.

2. A vehicle headlamp light distribution control apparatus which controls a light distribution of a headlamp of a vehicle, comprising:
acquiring means for acquiring positional coordinates of a marked position of a forward vehicle running in front of said vehicle;
optical axis control margin setting means for setting said optical axis control margin when the positional coordinates of the marked position, as derived by said acquiring means, are not present in front of said vehicle to be greater than that when the positional coordinates of the marked position are present in front of said vehicle;
cut-off line calculating means for, when said headlamp is a left headlamp, defining a location shifted from the positional coordinates of said marked position to the left by said optical axis control margin as the cut-off line of the left headlamp or, when said headlamp is a right headlamp, defining a location shifted from the positional coordinates of said marked position to the right by said optical axis control margin as the cut-off line of the right headlamp based on the positional coordinates of the marked position of said forward vehicle, as acquired by said acquiring means; and
control means for, when said headlamp is the left headlamp, controlling a light-distribution range of the left headlamp so as to shade a right side of said cut-off line or, when said headlamp is the right headlamp, controlling a light distribution range of the right headlamp so as to shade a left side of said cut-off line.

3. A vehicle headlamp light distribution control apparatus which controls a light distribution of a headlamp of a vehicle, comprising:
acquiring means for acquiring positional coordinates of a marked position of a forward vehicle running in front of said vehicle;
optical axis control margin setting means for setting said optical axis control margin when said vehicle is running on a curve to be greater than that when said vehicle is running straight;
cut-off line calculating means for, when said headlamp is a left headlamp, defining a location shifted from the positional coordinates of said marked position to the left by said optical axis control margin as the cut-off line of the left headlamp or, when said headlamp is a right headlamp defining a location shifted from the positional coordinates of said marked position to the right by said optical axis control margin as the cut-off line of the right headlamp based on the positional coordinates of the marked position of said forward vehicle, as acquired by said acquiring means; and
control means for, when said headlamp is the left headlamp, controlling a light-distribution range of the left headlamp so as to shade a right side of said cut-off line or, when said headlamp is the right headlamp, controlling a light distribution range of the right headlamp so as to shade a left side of said cut-off line.

4. A vehicle headlamp light distribution control apparatus which controls a light distribution of a headlamp of a vehicle, comprising:
acquiring means for acquiring positional coordinates of a marked position of a forward vehicle running in front of said vehicle;
optical axis control margin setting means for setting said optical axis control margin to be smaller with an increase in speed of said vehicle;
cut-off line calculating means for, when said headlamp is a left headlamp defining a location shifted from the positional coordinates of said marked position to the left by said optical axis control margin as the cut-off line of the left headlamp or, when said headlamp is a right headlamp, defining a location shifted from the positional coordinates of said marked position to the right by said optical axis control margin as the cut-off line of the right headlamp based on the positional coordinates of the marked position of said forward vehicle, as acquired by said acquiring means; and
control means for, when said headlamp is the left headlamp, controlling a light-distribution range of the left headlamp so as to shade a right side of said cut-off line or, when said headlamp is the right headlamp, controlling a light distribution range of the right headlamp so as to shade a left side of said cut-off line.

5. A vehicle headlamp light distribution control apparatus which controls a light distribution of a headlamp of a vehicle, comprising:
acquiring means for acquiring preceding/oncoming vehicle information for specifying positional coordinates that are a marked position of a forward vehicle running in front of said vehicle and determining whether the forward vehicle is a preceding vehicle or an oncoming vehicle;
vehicle type determining means for determining a type of said forward vehicle based on the preceding/oncoming vehicle information, as acquired by said acquiring means;
maximum shading range setting means for setting a maximum shading range that is a width between a given controlled center and a cut-off limit position based on a result of determination made by said vehicle type determining means, said maximum shading range setting means setting the maximum shading range when said vehicle type determining means determines that the oncoming vehicle is in front of said vehicle to be smaller than that when said vehicle type determining means determines that the preceding vehicle is in front of said vehicle;
cut-off line calculating means for calculating a cut-off line of said headlamp based on the based on the positional coordinates of the marked position of said forward vehicle, as acquired by said acquiring means; and
control means for determining whether said cut-off line lies in said maximum shading range or not, when said cut-off line lies in said maximum shading range, and said headlamp is a left headlamp, said control means controlling a light-distribution range of the left headlamp so as to shade a right side of said cut-off line or, when said cut-off line lies out of said maximum shading range, and said headlamp is a right headlamp, controlling a light distribution range of the right headlamp so as to shade a left side of said cut-off line.

6. A vehicle headlamp light distribution control apparatus which controls a light distribution of a headlamp of a vehicle, comprising:
acquiring means for acquiring preceding/oncoming vehicle information for specifying positional coordinates that are a marked position of a forward vehicle running in front of said vehicle and determining whether the forward vehicle is a preceding vehicle or an oncoming vehicle;
maximum shading range setting means for setting a maximum shading range that is a width between a given controlled center and a cut-off limit position to be smaller with an increase in speed of said vehicle;
cut-off line calculating means for calculating a cut-off line of said headlamp based on the based on the positional coordinates of the marked position of said forward vehicle, as acquired by said acquiring means; and
control means for determining whether said cut-off line lies in said maximum shading range or not, when said cut-off line lies in said maximum shading range, and said headlamp is a left headlamp, said control means controlling a light-distribution range of the left headlamp so as to shade a right side of said cut-off line or, when said cut-off line lies in said maximum shading range, and said headlamp is a right headlamp, controlling a light distribution range of the right headlamp so as to shade a left side of said cut-off line, when said cut-off line lies out of said maximum shading range, said control means placing the light distribution of said headlamp in a low-beam mode.
